(19) United States
(12) Patent Application Publication
(10) Pub. No.: US 2011/0275241 A1
(43) Pub. Date: Nov. 10, 2011

(54) PACKAGING TRAY FOR ACCOMMODATING ELECTRICAL CONNECTOR

(75) Inventors: JIN-JIANG ZHANG, Kunshan (CN); ZHENG-HUA XU, Kunshan (CN)

(73) Assignee: HON HAI PRECISION INDUSTRY CO., LTD., New Taipei (TW)

(21) Appl. No.: 13/099,409

(22) Filed: May 3, 2011

(30) Foreign Application Priority Data
May 7, 2010 (CN) 201020181888.0

(51) Int. Cl. H01R 13/60; H01R 43/20

(52) U.S. Cl. 439/527; 29/428

(57) ABSTRACT

A packaging tray (100) for accommodating an electrical connector (200) which has a central conductor (60) having a conductive tail (65) at a first level and an outer conductor (50) having a grounding tail (53) at a different second level, includes a cavity (10) defining a bottom wall (20), and opposite first and second side walls (310, 320). The first side wall defines a first indentation (311) for accommodating the grounding tail of the outer conductor. The second side wall defines a second indentation (321) for accommodating the conductive tail of the central conductor. The second indentation has a bottom face at a first level. The first indentation has a bottom face (313) at a different second level.

### BACKGROUND OF THE INVENTION

1. Field of the Invention

The present invention relates to a packaging tray, and more particularly to a packaging tray for accommodating and protecting a mini-RF (Radio Frequency) connector.

2. Description of Related Art

U.S. Pat. No. 6,902,408 issued to Yamane on Jun. 7, 2005 or U.S. Pat. No. 6,474,995 issued to Wu on Nov. 5, 2002 discloses an RF connector comprising an outer conductor having a tubular section and a grounding tail extending from the tubular section, a central conductor having a contact section extending in the axial direction in the tubular section, and a dielectric block molded to hold together both the conductors. The central conductor has a radial section extending outwardly in the radial direction from the bottom of the contact section and a conductive tail extending on the bottom face of the radial section for contact with a circuit board. The conductive tail of the central conductor is located at a bottom plane. The grounding tail of the outer conductor is located at a plane or level higher than the bottom plane.

Known packaging trays for such RF connectors do not account for this level difference in conductor tails such that mis-orientation of the connector to a circuit board might happen.

A packaging tray accommodating an electrical connector having tails located at different levels is desired.

### SUMMARY OF THE INVENTION

Accordingly, an object of the present invention is to provide a packaging tray accommodating and protecting an electrical connector having a grounding tail and a conductive tail located at different levels for avoiding mis-orientation of the electrical connector.

In order to achieve the object set forth, a packaging tray for accommodating an electrical connector which has a central conductor having a conductive tail at a first level and an outer conductor having a grounding tail at a different second level, includes a bottom wall in a cavity, and a number of side walls including opposite first and second side walls. The first side wall defines a first indentation for accommodating the grounding tail of the outer conductor. The second side wall defines a second indentation for accommodating the conductive tail of the central conductor. The second indentation has a bottom face at a first level. The first indentation has a bottom face at a different second level.

The grounding tail and the conductive tail are disposed at two different levels for avoiding mis-orientation of the electrical connector. The packaging tray is used to accommodate such an electrical connector for protecting purpose.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an electrical connector and a packaging tray accommodating the electrical connector in accordance with the present invention;

FIG. 2 is a perspective view showing the packaging tray;

FIG. 3 is another perspective view similar to FIG. 2, taken from another aspect;

FIG. 4 is an assembled view showing the electrical connector as shown in FIG. 1;

FIG. 5 is an exploded view showing the electrical connector as shown in FIG. 4; and

FIG. 6 is a cross-sectional view of packaging tray and the electrical connector, taken along line 6-6 of FIG. 1.

### DETAILED DESCRIPTION OF THE PREFERRED EMBODIMENT

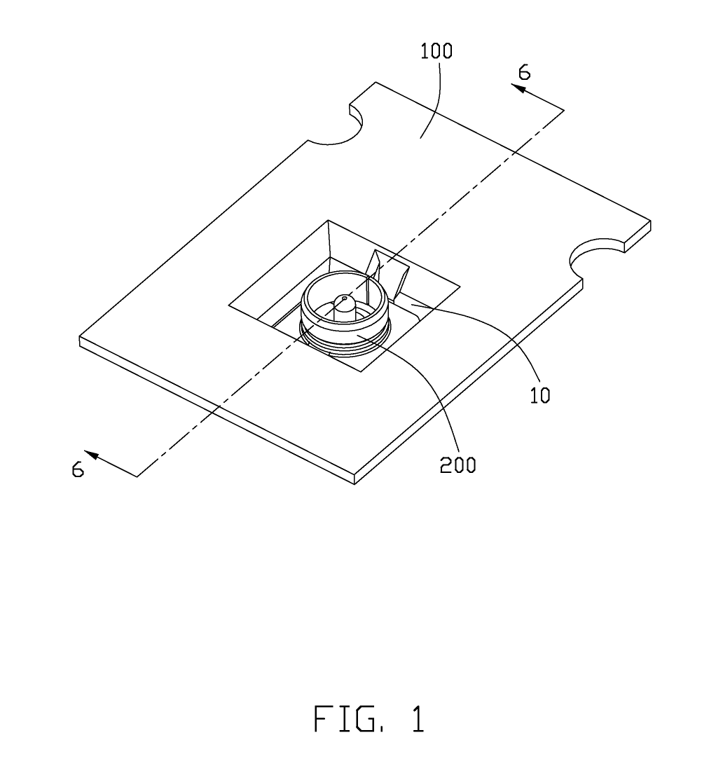

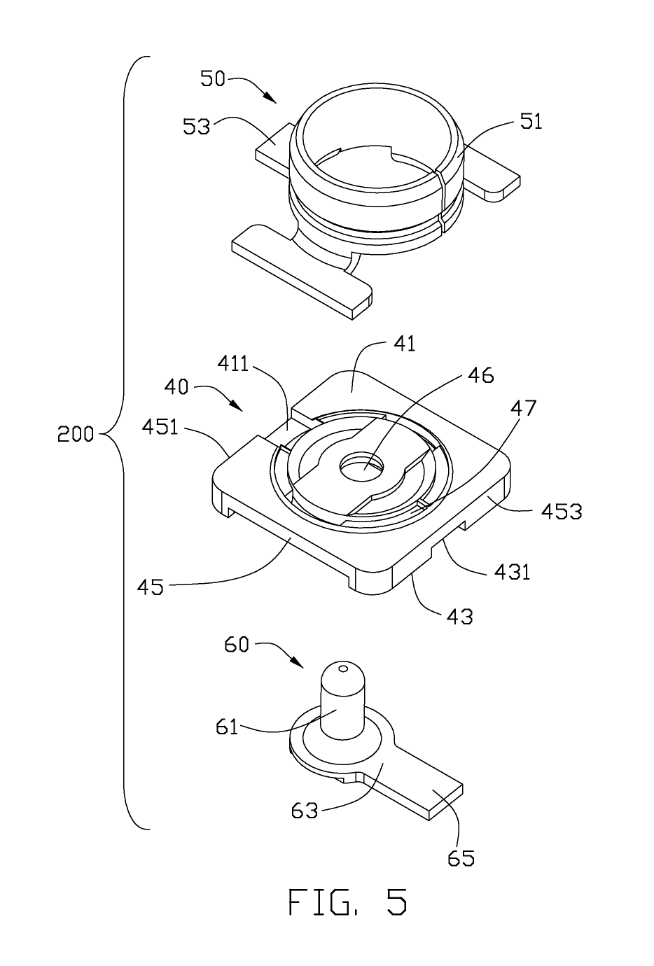

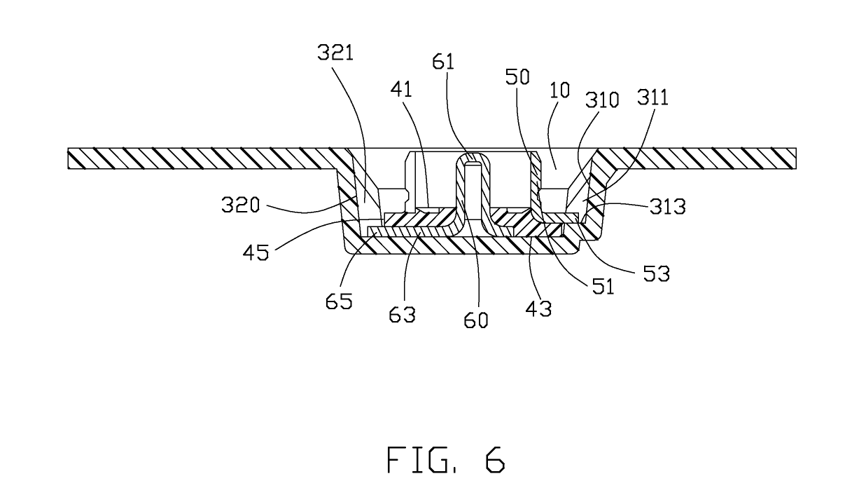

Reference will now be made in detail to the preferred embodiment of the present invention. Referring to FIGS. 1-6, an electrical connector 200 and a packaging tray 100 accommodating the electrical connector 200 are shown.

Referring to FIGS. 1-3, the packaging tray 100 is made from insulative material and defines one cavity 10 or a plurality of cavities 10 for accommodating corresponding number of electrical connectors 200.

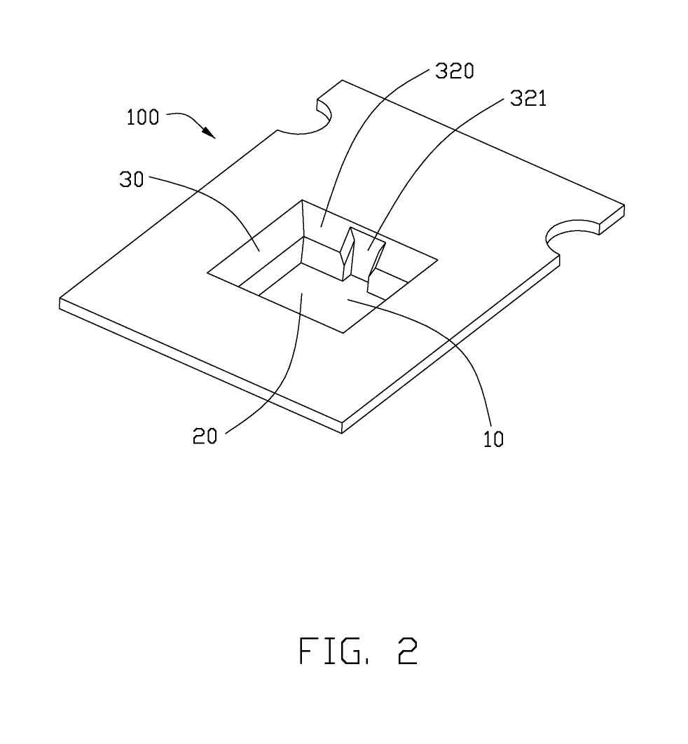

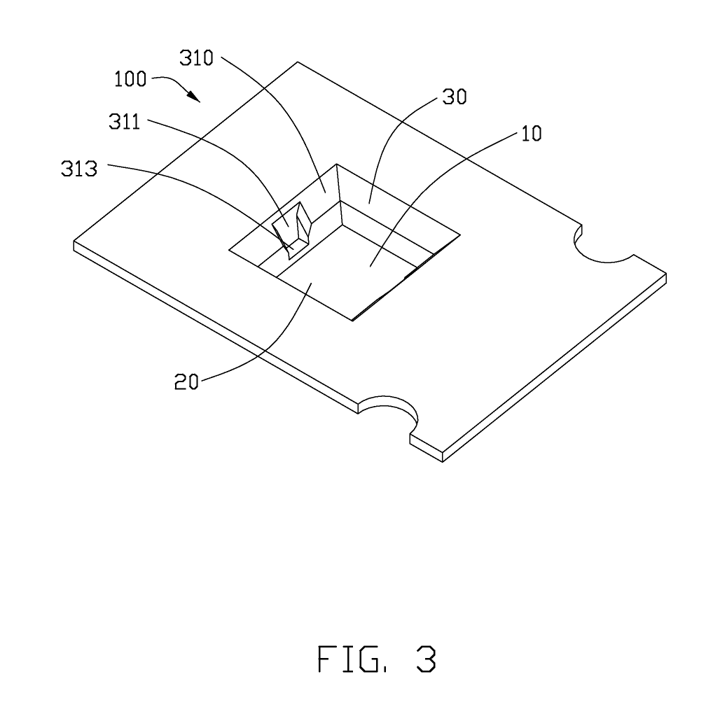

Referring to FIGS. 2-3, the packaging tray 100 includes a bottom wall 20 in the cavity 10, and a plurality of side walls 30 surrounding the cavity 10. The plurality of side walls 30 include a first side wall 310 and a second side wall 320 opposite to the first side wall 310. The first side wall 310 defines a first indentation 311 having a first bottom face 313. The second side wall 320 defines a second indentation 321 having a second bottom face. The second indentation 321 extends down to the level of the bottom wall 20. The second bottom face of the second indentation 321 is just part of the bottom wall 20, i.e., the two faces are leveled. The bottom wall 20 is located at the first level. The first bottom face 313 is located at the second level higher than the first level.

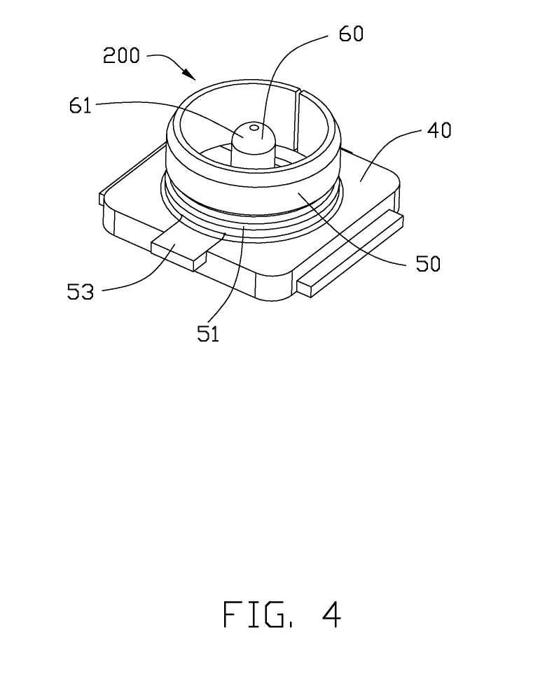

Referring to FIGS. 4-6, the electrical connector 200 includes a base 40, a central conductor 60 and an outer conductor 50 assembled to the base 40.

The base 40 includes a top face 41, a bottom face 43 and a plurality of side faces 45. The plurality of side faces 45 include a first periphery face 451 and a second periphery face 453. The base 40 defines a first recess 411 recessed from the top face 41 and extending through the first periphery face 451 for receiving the grounding tail 53 at a second level, and a second recess 431 recessed from the bottom face 43 and extending through the second periphery face 453 for receiving the conductive tail 65 at a first level. The top face 41 of the base 40 defines a central hole 46 and a rib 47 around the central hole 46.

The central conductor 60 includes a body portion 63, a contact portion 61 and a conductive tail 65 extending from the body portion 63. The outer conductor 50 comprises a tubular portion 51 and a grounding tail 53 extending from the tubular portion 51 along a radial direction.

When the assembled electrical connector 200 is accommodated in the cavity 10 of the packaging tray 100, the grounding tail 53 of the outer conductor 50 is confined in the first indentation 311 and is supported by the first bottom face 313. The conductive tail 65 of the central conductor 60 is received in the second indentation 321 and is supported by the bottom wall 20. The first distance between the first bottom face 313 and the bottom wall 20 is equal to a second distance between the grounding tail 53 and the conductive tail 65 of the electrical connector 200, along the vertical direction.

The grounding tail 53 and the conductive tail 65 are disposed at two different levels for avoiding mis-orientation. The packaging tray 100 is used to accommodate such an electrical connector 200 for protecting purpose.

In use, the electrical connector 200 is picked and placed by vacuum suction force out of the cavity 10 and onto a circuit board.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A packaging tray for accommodating an electrical connector which has a central conductor having a conductive tail at a first level and an outer conductor having a grounding tail at a different second level, comprising:
a cavity defining a bottom wall; and
a plurality of side walls including opposite first and second side walls, said first side wall defining a first indentation for accommodating the grounding tail of the outer conductor, said second side wall defining a second indentation for accommodating the conductive tail of the central conductor, said second indentation having a bottom face at a first level, said first indentation having a bottom face at a different second level.

2. The packaging tray as claimed in claim 1, wherein said second bottom face of the second indentation constitutes part of said bottom wall, and the second level is higher than the first level.

3. The packaging tray as claimed in claim 1, wherein both of said first and second indentations face toward the cavity.

4. Combination of a packaging tray and one or more electrical connectors,
the electrical connector comprising a central conductor having a conductive tail at a first level and an outer conductor having a grounding tail at a different second level; and
the packaging tray defining a cavity accommodating the electrical connector, the cavity having a bottom wall, and a plurality of side walls including opposite first and second side walls, said first side wall defining a first indentation for accommodating the grounding tail of the outer conductor, said second side wall defining a second indentation for accommodating the conductive tail of the central conductor, said first indentation having a first bottom face located at the second level, said second indentation having a second bottom face located at the first level.

5. The combination as claimed in claim 4, wherein the second bottom face of the second indentation constitutes part of the bottom wall, and the second level is higher than the first level.

6. The combination as claimed in claim 4, wherein said first and second indentations face toward the cavity.

7. A method of correctly loading an electrical connector into a cavity of a packaging tray, comprising steps of:
providing the electrical connector with a first rectangular configuration in a top view while having corresponding two SMT (surface mount) contact tails extending outwardly in two opposite lateral directions at two different levels; and
providing the packaging tray with the cavity defining a rectangular configuration in the top view similar to the first rectangular configuration and two opposite indentations in two opposite side walls beside the cavity with two different depths in compliance with the different levels of said two opposite SMT contact tails.

8. The method as claimed in claim 7, wherein each of said indentations defines at an upper end two chamfered structures opposite to each other in a transverse direction perpendicular to said two opposite lateral directions.
